(19) United States
(12) Patent Application Publication
(10) Pub. No.: US 2022/0280990 A1
(43) Pub. Date: Sep. 8, 2022

(54) METHOD FOR PRODUCING A TOWER SEGMENT AND TOWER SEGMENT

(71) Applicant: Wobben Properties GmbH, Aurich (DE)

(72) Inventors: Albrecht BRENNER, Aurich (DE); Bernd BOETTCHER, Aurich (DE); Alexander HOFFMANN, Emden (DE); Harro HARMS, Wiesmoor (DE)

(21) Appl. No.: 17/630,096

(22) PCT Filed: Jul. 22, 2020
(86) PCT No.: PCT/EP2020/070696

§ 371 Date: Jan. 25, 2022

(30) Foreign Application Priority Data
Jul. 25, 2019 (DE) 10 2019 120 175.6

(51) Int. Cl. B21C 37/18; E04H 12/08; E04H 12/34; F03D 9/34; F03D 13/20

(52) U.S. Cl. CPC B21C 37/185; E04H 12/085; E04H 12/342; F03D 9/34; F03D 13/20; F05B 2230/26; F05B 2230/232; F05B 2240/912; F05B 2280/10

(57) ABSTRACT

A manufacturing method for producing a tower segment, a tower portion and a tower section for a tower, in particular for a tower of a wind power installation. A tower segment, a tower portion and a tower section for a tower, in particular for a tower of a wind power installation, to a tower, and to a wind power installation. The manufacturing method comprises: providing a plate that extends in the longitudinal direction and, orthogonally thereto, in a circumferential direction, wherein the extent in the longitudinal direction is larger than the extent in the circumferential direction; and rolling the plate for incorporating a thickness profile along a longitudinal direction of the plate, wherein the rolling comprises: incorporating a first constant portion having a substantially constant first thickness which differs from a substantially constant second thickness of a second constant portion that in the longitudinal direction is disposed so as to be substantially parallel to said first constant portion; and bending the plate in the circumferential direction.

### BACKGROUND

### Technical Field

The invention relates to a manufacturing method for producing a tower segment, a tower portion and a tower section for a tower, in particular for a tower of a wind power installation. The invention furthermore relates to a tower segment, a tower portion and a tower section for a tower, in particular for a tower of a wind power installation, to a tower, and to a wind power installation.

### Description of the Related Art

A tower, for example a tower of a wind power installation, is usually in operation for several decades. Said tower is most typically not replaceable and to this extent has to be conceived for a comparatively long service life. However, such a tower, in particular for wind power installations, contributes largely to the overall costs of manufacturing a wind power installation.

EP 2 615 226 B1 relates to a tubular steel column construction to be used as a tower of a wind power installation and to a method for manufacturing the tubular steel column construction, comprising circular steel tubes that are in each case obtained by forming at least one steel plate having one or a plurality of portions, the latter having a variable plate thickness in the rolling direction, so as to form a ring.

While towers can indeed be manufactured by means of existing solutions, these towers are however worthy of improvement with a view to a long service life and low costs. The trend in development toward increasingly larger rotor diameters and nominal outputs of wind power installations boosts this demand. Because the development is moving toward larger towers which are exposed to higher loads, this is requiring an additional input of resources, for instance time, material, personnel, thus requiring higher costs in order to achieve a required service life despite the increasing loads.

The German patent and trademark office in the priority application pertaining to the present application has searched the following prior art: U.S. Pat. No. 8,752,337 B2, EP 2 615 226 B1, JP 2005-264 535 A; Hau, Erich: Windkraftanlagen, 6. Aufl. (Wind power installations, 6^{th} Edition), Berlin: Springer Vieweg; Brochure “Perfektion, die keinen kalt lasst: Elektrowerkzeug-Lösungen vor and nach dem Schweißen” (“Perfection which will not leave anyone out in the cold: pre- and post-welding power tool solutions”), by metabo, 72622 Nürtingen, Imprint September 2017.

### BRIEF SUMMARY

Provided is a manufacturing method for producing a tower segment, a tower portion and a tower section for a tower, a tower segment, a tower portion, a tower section for a tower, a tower and a wind power installation, said method minimizing or eliminating disadvantages of existing solutions. Provided is a manufacturing method for producing a tower segment, a tower portion and a tower section for a tower, a tower segment, a tower portion, a tower section for a tower, a tower and a wind power installation, said method simplifying and/or improving and/or rendering more cost-effective the manufacturing and/or the assembly of tower portions and/or towers of wind power installations. Provided is a manufacturing method for producing a tower segment, a tower portion and a tower section for a tower, a tower segment, a tower portion, a tower section for a tower, a tower and a wind power installation, said method improving the service life of a tower segment, of a tower portion, of a tower section for a tower, in particular for a tower of a wind power installation, and of a tower.

Provided is a manufacturing method for producing a tower segment of a tower, preferably of a tower of a wind power installation, said method comprising the steps: providing a plate that extends in a longitudinal direction and, orthogonally thereto, in a circumferential direction, wherein the extent in the longitudinal direction is larger than the extent in the circumferential direction; and rolling the plate so as to incorporate a thickness profile along the longitudinal direction of the plate, wherein the rolling comprises: incorporating a thickness profile having a variable thickness; and bending the plate in the circumferential direction. Towers of wind power installations in the installed state and in the operating state typically have a vertical longitudinal axis and, orthogonally to this longitudinal axis, an annular cross section. This annular cross section can be configured, for example, so as to be circular or elliptic, or else have a polygonal shape. The term annular in this application is not only understood to be a circular or elliptic design embodiment but also a polygonal and/or multi-angular design embodiment, as well as further design embodiments having a plurality of straight or curved portions.

Terms such as longitudinal, radial, tangential, circumference, radius, curvature, etc., in this application are preferably understood to relate to the longitudinal axis of a tower, and relate to any cross-sectional shape of such a tower, in particular to circular or elliptic cross sections as well as to polygonal cross sections.

An installed state here is in particular understood to be a state which relates to the vertically aligned tower and, to the extent that a corresponding nacelle having a rotor is disposed so as to be operationally ready on the tower, also corresponds to the operating state of the wind power installation. The installed state here does not mean a substantially horizontal alignment of the longitudinal axis, for example during manufacturing and/or assembling and/or when transporting the tower or parts thereof. The alignments described in the context of the installed state in the manufacturing and/or assembly state and/or transport state are to be correspondingly adapted to the longitudinal axis of the tower, or of a part of the latter, respectively, that is temporarily not vertically aligned.

A tower segment here is understood to be part of an annular tower portion, thus an element which extends over only part of the circumference of the tower. A plurality of tower segments disposed in the circumferential direction preferably form an annular tower portion. Longitudinal joints which are aligned so as to be substantially vertical, or in the longitudinal direction, respectively, can typically be configured between the tower segments in the installed state and in the operating state. It is known that tower segments can have the shape of a shell segment of a cylinder or cone or truncated cone, for example.

Two or more tower portions can form a tower section; the tower portion as the latter in the longitudinal direction extends only over part of the length of the tower section. A tower section is preferably formed from a plurality of annular tower portions, wherein circumferential joints which are aligned so as to be substantially horizontal can be configured between the annular tower portions in the installed state and in the operating state. A tower can comprise a plurality of tower portions which in the installed state and in the operating state of the wind power installation are disposed vertically on top of one another. Circumferential joints which are aligned so as to be substantially horizontal, or in the circumferential direction, respectively, can typically be configured between the tower portions disposed on top of one another in the installed state and in the operating state.

A tower section here is understood to be part of a tower, thus an element which in the longitudinal direction extends only over part of the length of the tower. A tower can comprise a plurality of tower sections which are disposed vertically on top of one another in the installed state and in the operating state of the wind power installation. The tower sections at the upper and/or lower end thereof preferably have connector elements by means of which tower sections can be fastened, in particular screwed, to one another.

Towers of wind power installations are typically tapered from the lower end thereof to the upper end thereof. The alignment of the tower wall of a tapering tower typically deviates from the vertical by only a few degrees. When reference in this application is made to alignments, in particular in the installed state or in the operating state, such as, for example top, bottom, radial, horizontal, vertical, tangential, longitudinal, circumference, curvature, radius, etc., this is therefore also to apply in analogous manner to tapering towers, and accordingly to tower walls which are slightly inclined in relation to the vertical.

Different construction modes for towers of wind power installations are known. Towers in a solid construction mode, from concrete and/or ferroconcrete and/or prestressed concrete and/or steel have in particular proven to be successful. To this extent, tower segments are preferably made of concrete and/or ferroconcrete and/or prestressed concrete and/or steel.

In particular by virtue of the large diameter of annular tower portions, of a circular-annular as well as elliptic or else polygonal shape, it is known for tower portions to be divided in the longitudinal direction and the circumferential direction so as to form tower segments. Such tower segments are easier to manufacture and/or transport than annular tower portions. The tower segments typically have a planar extent, the latter forming the tower wall. The tower segment, in a manner orthogonal and/or radial in relation to the planar extent, has a thickness, thus a wall thickness, which typically is multiple times smaller than the planar extent.

Tower segments for towers having a polygonal cross section are typically configured so as not to be flat. In particular, tower segments for towers having a polygonal cross section are typically not flat in the circumferential direction. Such tower segments for towers having a polygonal cross section preferably have a kink or an edge, respectively. The kink or the edge, respectively, can in particular extend in the longitudinal direction of the tower segment. It is furthermore conceivable in particular that tower segments for towers having a polygonal cross section are configured so as to be flat. In particular, such tower segments of a flat configuration do not have any curvature in the planar extents thereof—neither in the circumferential direction nor in the longitudinal direction. In contrast, tower segments for towers having a circular-annular or elliptic cross section typically have a curvature or radius, respectively, in the planar extent thereof, in particular in the circumferential direction. Tower segments for towers having a circular-annular cross section preferably have a curvature which is substantially constant in the circumferential direction. Tower segments for towers having an elliptic cross section preferably have a curvature which substantially varies in the circumferential direction. In particular, the curvature in the circumferential direction can vary along the longitudinal direction of a tower segment.

In the solution described here, the provided plate in the longitudinal direction has an extent, also referred to as the length, which is multiple times greater than the extent in the circumferential direction, also referred to as the width. The length-to-width ratio of the plate is preferably 3:1 or more, and in particular 4:1 or more. For example, the plate has a length of approximately 12 m and a width of approximately 3 m or 4 m. The plate preferably has a thickness of at least 18 mm and at most 60 mm. Lengths and/or widths and/or thicknesses that deviate therefrom are also conceivable. The plate to be provided in the longitudinal direction and/or in the circumferential direction preferably has a substantially constant extent and/or a constant thickness.

The plate to be provided is in particular an integral plate. An integral plate is preferably produced by a primary forming and/or forming and/or additive manufacturing method. An integral plate is in particular not assembled, for instance welded or screwed together, from two or a plurality of plates.

The thickness of the plate can preferably be variably adjusted by means of the method step of rolling. The rolling is, for example, longitudinal rolling or forge rolling. When rolling, the plate to be rolled, in a manner orthogonal in relation to two or a plurality of roller axes, is preferably conveyed through a roller gap defined between two rollers. The resulting conveying direction or rolling direction, respectively, preferably corresponds substantially to the longitudinal direction of the plate to be rolled. The roller axes are preferably aligned so as to be substantially orthogonal in relation to the longitudinal direction of the plate to be rolled, and the rollers are disposed so as to be mutually parallel. One or a plurality of roller pairs can convey the plate to be rolled during rolling. The thickness of the plate can be adjusted by adjusting the roller gap.

A thickness profile which is variable in the longitudinal direction of the plate is preferably incorporated by means of rolling. Such a variable thickness profile comprises at least two different thicknesses. A portion of a thickness profile having a variable thickness is also referred to as a transition portion. The tower segment in the longitudinal direction preferably comprises one transition portion. It can furthermore be preferable for the tower segment in the longitudinal direction to have a plurality of transition portions. It is furthermore particularly conceivable that a thickness profile of a tower segment which varies in the longitudinal direction can have one or a plurality of portions of constant thickness. A portion of a thickness profile having a constant thickness is also referred to as a constant portion. It may also be preferable for the thickness profile in the longitudinal direction to have one or a plurality of portions having a variable thickness (transition portion) and to have one or a plurality of portions having a constant thickness (constant portion).

The thickness of the thickness profile in the longitudinal direction of the plate can in particular increase from an end of the tower segment which in the installed state is a lower end to an upper end. A tower segment from an end of the tower segment which in the installed state is a lower end to an upper end preferably has one or a plurality of transition portions that increase in terms of thickness, and/or one or a plurality of transition portions that decrease in terms of thickness, and/or one or a plurality of constant portions. A thickness profile having a portion of increasing thickness can have one or a plurality of portions of constant thickness. It is furthermore preferable that the thickness of the thickness profile in the longitudinal direction of the plate, from an end of the tower segment which in the installed state is a lower end decreases to an upper end. A thickness profile having a portion of decreasing thickness can have one or a plurality of portions of constant thickness. It is particularly preferable that the thickness profile in the longitudinal direction has one or a plurality of portions with a convex thickness profile, and/or one or a plurality of portions with a concave thickness profile. The thickness profile in the longitudinal direction can preferably have one or a plurality of portions of stepped thickness profiles.

The thickness of the thickness profile in the longitudinal direction of the plate, proceeding from the end of the tower segment which in the installed state is the lower end, can increase to a center of the plate and/or decrease from the center of the plate to the upper end. Furthermore, the thickness of the thickness profile in the longitudinal direction of the plate, proceeding from the end of the tower segment which in the installed state is the lower end, can preferably decrease to the center and/or increase to the upper end. The thickness of the thickness profile in the longitudinal direction of the plate, proceeding from the end of the tower segment which in the installed state is the lower end, is preferably constant to the center and/or constant to the upper end. Further combinations of an increasing, decreasing and constant thickness of the thickness profiles in the longitudinal direction of a plate, from the end of the tower segment which in the installed state is the lower end, to the upper end of said tower segment, are in particular conceivable.

The variable thickness profile of a tower segment preferably has a continuous variation of the thickness of the tower segment. The variable thickness profile of the tower segment can also have one or a plurality of discrete variations of the thickness. In the case of a discrete variation of the thickness, the thickness profile of the tower segment can have a kink or a step, for example. The incorporated thickness profile of a tower segment can in particular have continuous as well as discrete variations of the thickness.

A thickness which is substantially constant in the circumferential direction of the plate is in particular incorporated when rolling in the longitudinal direction of the plate. A thickness which is variable in the circumferential direction of the plate can also be preferably incorporated when rolling in the longitudinal direction of the plate. The rolling comprises in particular conical rolling for incorporating a thickness which varies in the circumferential direction of the plate.

A greater thickness can in particular be incorporated in those portions of the plate that in the installed state, or in the operating state, respectively, are assembled in highly stressed regions of the tower. It is furthermore preferable for a greater thickness to be incorporated in those portions which are to be connected to a tower segment which in the installed state, or in the operating state, lies above or below, those portions usually being the uppermost and lowermost portion of a plate in the longitudinal direction. It is furthermore preferable for a greater thickness to be incorporated in those portions on which recesses, fastening connectors, etc., are provided.

The method step of bending comprises the bending of the plate in the circumferential direction, the plate by means of a bending tool being in particular bent about a bending axis orthogonal to the rolling direction. The bending axis is substantially parallel to the longitudinal direction of a plate to be bent. A bending stress which is above the yield point of the material of the plate is in particular to be induced when bending. The bent plate in the installed state or operating state, respectively, in relation to the longitudinal axis preferably has a radius or a curvature, respectively. The bending preferably comprises the incorporating of a kink and/or an edge. The method step of bending comprises in particular those manufacturing methods which are suitable for incorporating a curvature, a kink and/or an edge in the circumferential direction of the plate.

The method step of bending preferably comprises or is pressing and/or forging and/or deep drawing and/or rolling. The method step of bending furthermore comprises or is edge-bending and/or buckling.

The solution described here is based on inter alia the concept that circumferential joints in steel towers may have an unfavorable effect in terms of resistance to fatigue. The invention is in particular based on the concept that a minimum number of circumferential joints improves the resistance of such towers to fatigue. An advantage of the manufacturing method lies in that a tower segment by way of which the number of circumferential joints in the tower can be reduced and the service life of the tower increased can be manufactured.

A further advantage of the manufacturing method lies in that the thickness of a tower segment in the longitudinal direction can be incorporated according to requirements, for example as a function of the load to be expected or the ease of assembly. The complexity in terms of the material input, the weight, the complexity of the assembly and thus costs can in particular be reduced by this manufacturing method. A further advantage of the manufacturing method lies in that the service life of the tower can be extended while using the same material input.

It is furthermore advantageous that the wall thickness, or the thickness of a tower, respectively, in the circumferential direction can be adjusted according to requirements, in particular according to loads, by way of this manufacturing method for producing a tower segment. Tower segments having a greater thickness can thus advantageously be produced for the prevailing load direction of a tower, and tower segments having a lesser thickness can be produced for those regions of the tower that are subject to a lower load.

According to one preferred embodiment, the step of rolling comprises the heating of the plate to a hot-rolling temperature; and/or incorporating at least one transition portion, wherein the transition portion has a variable thickness of the incorporated thickness profile; and/or incorporating at least one constant portion, wherein the constant portion has a constant thickness of the incorporated thickness profile.

In terms of the method step of rolling it is known for heating of a plate to be rolled to be provided. Rolling of the heated plate is also referred to as hot-rolling. In the step of heating, the plate is preferably heated to a hot-rolling temperature which is above an ambient temperature. When hot-rolling, the plate to be rolled is in particular heated to a hot-rolling temperature which is above the recrystallization temperature of the material of the plate to be rolled. For example, the plate to be rolled is preferably heated to a hot-rolling temperature of approximately 1250° C.

The incorporating of a thickness profile having a variable thickness along the longitudinal direction of the plate preferably comprises the incorporating of at least one transition portion and/or the incorporating of at least one constant portion. The thickness profile incorporated in the plate preferably has one or a plurality of transition portions and/or one or a plurality of constant portions. The rolling preferably comprises the incorporating of at least two, three, four, six, eight or twelve transition portions and/or constant portions. It is conceivable in particular that a thickness profile incorporated in the longitudinal direction in a plate has only a single transition portion and/or only a single constant portion. A constant portion is preferably incorporated on an end of a tower segment which in the installed state is an upper and/or lower end. Embodiments in which a transition portion is preferably incorporated on an end of a tower segment which in the installed state is an upper and/or lower end are also conceivable.

A variable thickness profile of a tower segment, in the longitudinal direction from an end of the tower segment which in the installed state is a lower end to an upper end of the tower segment can have one or a plurality of transition portions of increasing thickness and/or one or a plurality of transition portions of decreasing thickness and/or one or a plurality of constant portions. A variation of the thickness of the transition portion of the thickness profile is preferably continuous. The continuous variation of the thickness is in particular a consistent variation of the thickness. The continuous variation of the thickness is preferably not an abrupt variation of the thickness. In the case of an abrupt variation of the thickness, the thickness profile can have a kink or a step, for example. A transition portion can have, for example, a convex, concave or trapezoidal thickness profile, or a combination thereof. In the case of a combination thereof, the transitions of the variation of the thickness between the convex, concave and/or trapezoidal thickness profile of one portion are in particular consistent.

A thickness which is constant in the circumferential direction and the longitudinal direction is preferably incorporated in each constant portion by means of rolling. In particular, the thickness of the tower segment does not substantially vary within one constant portion. A constant thickness of a constant portion may fluctuate within the usual manufacturing-related tolerances. The thickness profile of a tower segment in the longitudinal direction of the plate can have a first constant portion having a first thickness, and a second constant portion having a second thickness. The first thickness is preferably different from the second thickness; the first thickness is in particular greater than the second thickness. It is furthermore preferable that the rolling comprises incorporating a thickness profile having more than two constant portions, each having different thicknesses. It is conceivable that, in a tower segment having a plurality of constant portions, two or more constant portions have the same thickness. In particular, a plurality of constant portions of a tower segment incorporated with a constant thickness have mutually different thicknesses. The thicknesses of adjacent constant portions of a tower segment preferably deviate from one another by at most 250%, particularly preferably by at most 200%, most particularly however at most by 150%. A transition portion can in particular be incorporated between adjacent constant portions in the longitudinal direction.

A variation of the thickness of the thickness profile in the longitudinal direction from a transition portion to a constant portion is preferably continuous. It can however also be preferable that a variation of the thickness of the thickness profile in the longitudinal direction from a transition portion to a constant portion, or between two adjacent constant portions, has a discrete profile. A discrete profile between adjacent portions has in particular an abrupt variation.

One or a plurality of incorporated transition portions and/or constant portions of a tower segment in the longitudinal direction preferably have an extent which is smaller than the extent of the tower segment in the circumferential direction. It is furthermore preferable that one or a plurality of incorporated transition portions and/or constant portions of a tower segment in the longitudinal direction have an extent which is larger than the extent of the tower segment in the circumferential direction. It is particularly preferable that one or a plurality of incorporated transition portions and/or constant portions of a tower segment in the longitudinal direction have an extent which is smaller than the extent of the tower segment in the circumferential direction, and one or a plurality of incorporated transition portions and/or constant portions of a tower segment in the longitudinal direction have an extent which is larger than the extent of the tower segment in the circumferential direction. It can be particularly preferable that one or a plurality of transition portions in the longitudinal direction of a tower segment have a larger extent than one or a plurality of constant portions.

As a result of the heating of the plate, the thickness profile to be incorporated can advantageously be incorporated in a substantially easier and more precise manner. Costs when rolling the plate can in particular be saved as a result of the heating.

A further advantage as a result of a constant thickness being incorporated in the longitudinal direction and the circumferential direction of each constant portion lies for example in that tools and molds of less complexity can be utilized for producing a tower segment, and costs can be saved.

It is furthermore advantageous that the notching effect in tower segments produced in such a way is reduced in particular as a result of a transition portion being incorporated between adjacent constant portions, the service life of towers which comprise tower segments produced in such a way thus being increased. A further advantage lies in that material can be saved while maintaining the service life of a tower segment, or of a tower, respectively.

According to one further preferred embodiment, a transition portion and a constant portion are incorporated in the plate in such a manner that the transition portion in the installed state is disposed above or below the constant portion. The transition portion and the constant portion are in particular disposed in such a manner that the transition portion in the longitudinal direction transitions to the constant portion. The transition portion and the constant portion are preferably disposed so as to be substantially mutually parallel. Disposed so as to be mutually parallel means that the transition portion across the entire width of the tower segment transitions to the constant portion in a manner substantially perpendicular to the extent of the tower segment in the circumferential direction.

Such an arrangement has the technical effect that the thickness profile of a tower segment in the longitudinal direction can be incorporated so as to be particularly appropriate for the loads to be anticipated in the installed state or operating state, respectively. In particular, this preferred arrangement has the advantage that the material input is further reduced.

In one preferred embodiment of the manufacturing method it is furthermore provided that at least one transition portion in the longitudinal direction is incorporated and disposed between two incorporated constant portions; and/or at least one constant portion in the longitudinal direction is incorporated and disposed between two incorporated transition portions.

For connecting two adjacent constant portions of a tower segment the rolling preferably comprises the incorporating of a transition portion between two adjacent tower segments. The transition portion between the two constant portions is in particular incorporated in such a manner that the transition of the thickness profile in the longitudinal direction is preferably continuous between the individual portions. It can be preferable that a transition of the thickness profile in the longitudinal direction from the one constant portion to the transition portion is continuous, and the further transition of the thickness profile from the transition portion to the further constant portion has a discrete profile. It is furthermore conceivable that the transitions of the thickness profile between the transition portion and the two constant portions each have a discrete profile.

The contact portions between which the transition portion is incorporated preferably have mutually different thicknesses. The thickness of the transition portion can vary between the thicknesses of the constant portions. The incorporating of a transition portion comprises in particularly adapting the thickness from the first to the second constant portion. When incorporating the transition portion, the thickness in the longitudinal direction of the plate to be rolled can increase or decrease. The length of the respective transition portion and/or the variation of the thickness across the length is in particular to be incorporated as a function of manufacturing-related restrictions, for instance the roller diameters and/or with a view to a preferably minimal notching effect. When incorporating a transition portion, the length of a transition portion is preferably larger than the length of at least one of the two constant portions to be connected. The transition portion can in particular also be longer than the constant portions to be connected. It can also be preferable that the transition portion to be incorporated is incorporated by way of a length which is smaller than the length of at least one of the two constant portions to be connected.

The embodiments apply in analogous manner to the constant portion which in the longitudinal direction is incorporated and disposed between two incorporated transition portions.

Such an arrangement has the technical effect that the notching effect is particularly advantageously reduced on transitions between portions having different thicknesses, in particular between constant portions having different thicknesses. In particular, this preferred arrangement has the advantage of further reducing the material input.

In one preferred embodiment, the step of bending comprises the heating of the plate to a hot-bending temperature; and/or incorporating a curvature in the circumferential direction in the plate, wherein the incorporating of the curvature preferably comprises incorporating the curvature by means of plastic hot-forming and/or preferably incorporating a curvature which is constant in the circumferential direction of the plate; and/or disposing on top of one another at least two plates substantially orthogonal to the longitudinal direction and the circumferential direction of the plate; and/or disposing the plate on a mold. The mold is preferably a mesh mold, and in particular a mesh mold with a cover panel. It is furthermore preferable for the mold to be a concrete block.

As a result of the plate being heated to a hot-bending temperature, the plate can advantageously be bent using a lower bending force. The hot-bending temperature is preferably to be chosen or adjusted, respectively, in such a temperature interval in which the microstructure of the plate to be bent is not modified in relation to the microstructure at room temperature. The plate is preferably heated to a hot-bending temperature of approximately 630° C. The plate is in particular plastically hot-formed. As a result of the plastic hot-forming, the plate can be bent using a lower bending force in comparison to forming at room temperature, and a corresponding curvature be incorporated. It is provided that a constant portion preferably has a curvature which is constant in the circumferential direction. Cylindrical tower segments and cylindrical constant portions have a substantially constant curvature in the longitudinal direction. In particular the plastic hot-forming advantageously reduces the risk of material ruptures or the formation of wrinkles, thus potentially increasing the service life of the tower segment and reducing the reject rate, for example. Plates to be bent are preferably hot-formed in a conical manner.

In particular, a plurality of plates can be bent in a single procedure. To this end, two or more plates can be disposed on top of one another. A curvature can be incorporated in the plates disposed on top of one another, for example by means of the plastic hot-forming. The simultaneous bending of plates disposed on top of one another can advantageously save manufacturing time and thus costs.

The mold is preferably a negative shape of the tower segment to be manufactured. The mold in the circumferential direction is in particular a concave and/or convex negative shape of the tower segment. The mold in the circumferential direction and/or in the longitudinal direction has in particular a curvature which corresponds to the curvature of the tower segment to be produced in the circumferential direction and/or the longitudinal direction. The shape for the respective tower segment to be manufactured can advantageously be achieved in a rapid and cost-effective manner by a mesh mold, in particular by a mesh mold having cover panels, or by a mold as a concrete block. Furthermore, the heat as a function of the hot-bending temperature can be discharged from the plate in a rapid and cost-effective manner by the mesh mold.

In one preferred embodiment it is provided that the thickness of the at least one transition portion varies in a stepless or stepped manner, and/or the curvature incorporated in the circumferential direction varies along the longitudinal direction of the plate.

A tower segment, having a stepless as well as a stepped transition portion, produced according to this embodiment under load advantageously has a reduced notching effect and thus an increased service life. When incorporating the transition portion, the transition from the first constant portion to the transition portion, and the transition from the transition portion from the second constant portion, are advantageously incorporated so as to be radiused. A stepless transition portion in a manner substantially orthogonal to the circumferential direction has a trapezoidal thickness profile, for example. The thickness in the case of a trapezoidal thickness profile decreases or increases in a constant (linear) manner, respectively. Alternatively and/or additionally, it can also be preferable that a stepless transition portion has a convex and/or concave thickness profile. In the case of a stepped transition portion, the thickness profile has one or a plurality of discrete variations in the thickness profile. A stepped transition portion comprises in particular an inconsistent thickness profile.

The curvature, or the radius, respectively, of a tower segment in the installed state can vary in the longitudinal direction, in particular as a function of the inclination of the tower segment, or of the tower, respectively, in the installed state or operating state, respectively, in relation to the longitudinal axis. In particular, a tower segment which in the installed state or operating state, respectively, is inclined in relation to a longitudinal axis, or a conical tower segment, respectively, has a variable curvature in the longitudinal direction. A tower segment which in the installed state tapers from the bottom to the top has a curvature in the circumferential direction that is a function of the length or the height of the tower segment, respectively. The curvature of a tapered tower segment increases in particular from the bottom to the top, thus as the height increases.

A transition portion of such a particular design embodiment has the technical effect of particularly suitably reducing the notching effect which arises on the tower segments under load. Furthermore, a curvature that varies in the circumferential direction has the advantage that the thickness of the tower segment can be adjusted so as to be appropriate to the load. A tower segment of such an embodiment has in particular the technical effect of saving material. The service life of a tower segment or of a tower, respectively, can in particular be increased while maintaining the input of material.

In one further preferred embodiment, the manufacturing method comprises the step of producing at least one abutting face on the plate for connecting at least one further plate, wherein the producing of the at least one abutting face comprises the producing of at least one longitudinal abutting face for connecting at least one further plate in the circumferential direction, and/or the producing of at least one circumferential abutting face for connecting at least one further plate in the longitudinal direction, and/or the removing of a peripheral portion of the plate.

The producing of an abutting face comprises in particular the separating, for example the subtracting, the punching or the eroding. The producing of the abutting face comprises in particular preparatory steps for connecting plates to one another. It is particularly preferable that the abutting face to be produced is configured for a butt joint. It can furthermore be provided that the abutting face to be produced is configured for an overlap joint. For example, the abutting face for an overlap joint can be produced for a screw connection. The abutting faces are particularly preferably configured for a welded connection. The producing of the abutting face comprises in particular the producing of a seam shape for a welded connection. For example, the seam shapes to be produced preferably include the I seam, V seam, HV seam, Y seam, HY seam, etc.

The step of producing abutting faces preferably comprises the producing of a longitudinal abutting face and the producing of a circumferential abutting face which is aligned so as to be substantially orthogonal to the longitudinal direction. Two or a plurality of tower segments can be connected to one another in the circumferential direction as a result of producing a longitudinal abutting face. Preferably eight, particularly preferably ten or more, tower segments form an annular tower portion. The number of circumferential abutting faces in a tower can advantageously be reduced and the service life increased as a result of the plates being connected by way of the longitudinal abutting faces.

The removing of a peripheral portion of the tower segment comprises in particular the adjusting or achieving, respectively, of a required inclination of the tower. In particular, gas cutting, plasma cutting, laser cutting or water-jet cutting are suitable manufacturing methods for removing a peripheral portion from a plate. The removing of a peripheral portion from a plate can furthermore take place by subtractive manufacturing methods.

According to a further aspect, provided is a manufacturing method for establishing a tower portion, said method comprising the step: connecting two plates produced according to a previously described manufacturing method at the corresponding longitudinal abutting faces, wherein the connecting comprises: disposing and fixing adjacent plates on one another along the longitudinal abutting faces so as to form an annular tower portion in the circumferential direction; and establishing a longitudinal welded connection between the adjacent plates along the longitudinal abutting faces.

In this way, the thickness in the circumferential direction in an annular tower portion can vary as a function of the load arising in the installed state or operating state, respectively. In particular, such plates or tower segments, respectively, which are disposed transversely and/or substantially transversely to the prevailing load direction, for example transversely to the prevailing wind direction, can have a greater thickness than tower segments which in the installed state or operating state, respectively, are disposed so as to be substantially parallel to the prevailing load direction. The thickness profiles of tower segments which are to be connected and adjacent in the installed state are preferably similar. The thickness of tower segments to be connected preferably varies in the circumferential direction of a tower portion to be established. In particular, the thickness of tower segments to be connected decreases and/or increases in the circumferential direction of the tower portion.

In particular, two plates can be connected to one another, wherein a first thickness profile of a first portion or a second thickness profile of a second portion of a first tower segment differ from a first thickness profile of a first portion or from a second thickness profile of a second portion of a second tower segment. The first thickness profile of the first portion of the one plate and the first thickness profile of the first portion of the other plate are preferably substantially identical. Furthermore preferably, the second thickness profile of the second portion of the one plate and the second thickness portion of the second portion of the other plate are substantially identical. The first thickness profile of the first portion of the one plate is particularly preferably different from the first thickness profile of the first portion of the further plate, and/or the second thickness profile of the second portion of the one plate is different from the second thickness profile of the second portion of the further plate. The first portion in the longitudinal direction of the tower segment in the installed state is preferably disposed below the second portion. The first and the second portion can be a transition portion as well as a constant portion. In particular, the abutting faces of the tower segments to be connected are similar.

As a result of plates being connected at the longitudinal abutting faces, a tower portion over the height thereof has a substantially lower number of circumferential abutting faces in comparison to conventional towers, and to this extent also has in particular a lower number of circumferential welded connections. In this way, the notch resistance and in particular the service life of towers having tower portions produced in such a way can be significantly increased. Furthermore, the complexity in terms of maintenance and/or inspection decreases along with the lower number of circumferential welded connections.

Adjacent plates are preferably connected to one another by way of a butt joint. It is furthermore conceivable for the two plates to be connected to one another by way of an overlap joint or a crimped joint. The establishing of a longitudinal weld seam connection preferably comprises the establishing of an I seam, V seam, HV seam, Y seam, HY seam, etc. In particular, a longitudinal weld seam connection is provided at the corresponding longitudinal abutting faces.

According to a further aspect, provided is achieved by a manufacturing method for establishing a tower section, said method comprising the step: connecting two or a plurality of tower portions produced according to a previously described manufacturing method at the corresponding circumferential abutting faces, wherein the connecting comprises: disposing and fixing adjacent tower portions on one another along the circumferential abutting faces so as to form a tower section in the longitudinal direction; and establishing a circumferential welded connection between the adjacent tower portions along the circumferential abutting faces.

The embodiments pertaining to the previously described method step of connecting two plates at the corresponding longitudinal abutment faces applies in an analogous manner for the establishing of a tower section, in particular for the connecting of two or more tower portions. Tower sections having a length of approximately 24 m or 28 m are preferably established.

Tower sections established in this way have a comparatively low number of circumferential welded connections. This reduced number of circumferential welded connections has a particularly positive effect on the service life of towers that comprise such tower sections. A further advantage lies in that material can be saved while maintaining the same service life of a tower segment, or of a tower, respectively.

In one preferred embodiment, the manufacturing method comprises the step of grinding the circumferential welded connection and/or grinding the longitudinal welded connection, and/or annealing the plates in the region of the circumferential welded connection and/or annealing the longitudinal welded connection. Additionally and/or alternatively, further post-treatment steps can in particular also be carried out.

The grinding comprises in particular the flat grinding of the circumferential welded connection and/or longitudinal welded connection. In flat grinding, the corresponding welded connection is preferably ground so as to be planar in relation to the external tower wall and/or the internal tower wall. In this way, the notching effect of the tower section in the installed state or operating state, respectively, can advantageously be reduced. A tower section having a ground and/or annealed circumferential welded connection has in particular a significantly reduced notching effect and thus an increased service life. Tower sections in which the circumferential welded connection as well as the longitudinal welded connection are ground and annealed are particularly preferable.

According to one further aspect, provided is a tower segment of a tower, in particular of a tower of a wind power installation, comprising a plate, wherein the plate extends in a longitudinal direction and, orthogonally thereto, in a circumferential direction, wherein the extent in the longitudinal direction is larger than the extent in the circumferential direction, and wherein the plate has a thickness profile having a variable thickness along the longitudinal direction of the plate, having at least one transition portion having a variable thickness; and/or at least one constant portion having a substantially constant thickness; and/or the plate in the circumferential direction has a curvature. The thickness profile of the tower segment preferably transitions continuously from the transition portion to the constant portion. The plate has in particular a transition portion, wherein the transition portion is disposed between a first and a second constant portion. The thickness of the transition cross section in the longitudinal direction of the plate preferably varies between the first thickness and the second thickness of the first and the second constant portion.

According to one further aspect, provided is a tower portion of a tower, in particular of a tower of a wind power installation, comprising two, three or a plurality of previously described tower segments, wherein the tower segments in the circumferential direction are disposed in an annular manner or as an annular sub-portion, and adjacent tower segments are fastened to one another at the longitudinal abutting faces. In particular, the tower segments that are adjacent in the circumferential direction are fastened to one another at the longitudinal abutting faces by means of a longitudinal welded connection.

In one preferred embodiment of the tower portion it is provided that the thickness in the installed state differs in the circumferential direction, in particular between at least two tower segments.

According to one further aspect, provided is a tower section of a tower, in particular of a tower of a wind power installation, comprising two, three or a plurality of previously described tower portions, wherein the tower portions, in the installed state, in the longitudinal direction are disposed on top of one another, and adjacent tower portions are fastened to one another at the circumferential abutting faces. For example, it is particularly preferable that the respective longitudinal abutting faces of the tower portions that in the longitudinal direction are disposed on top of one another are in mutual alignment. It is, however, also preferable for adjacent tower portions in the longitudinal direction to be disposed on top of one another in such a manner that the longitudinal abutting faces of the respective tower portions are offset in the circumferential direction, the tower portions thus being disposed in the manner of brickwork. In particular, the tower portions that are adjacent in the longitudinal direction are fastened to one another at the circumferential abutting faces by means of a circumferential welded connection.

According to one preferred embodiment of the tower section it is provided that the tower section on an end which, in the installed state, in the longitudinal direction is an upper end has an upper annular flange for fastening a further tower section or a nacelle, and/or on an end which, in the installed state, in the longitudinal direction is a lower end has a lower annular flange for fastening a further tower section or a foundation.

According to one further aspect, provided is a tower, comprising a previously described tower section.

According to one further aspect, provided is a wind power installation, comprising a previously described tower.

According to one further aspect, provided is a use of a previously described tower segment and/or of a previously described tower portion and/or of a previously described tower section in a tower, in particular in a tower for a wind power installation.

The tower segment, the tower portion, the tower section, the tower and the wind power installation, and the respective potential refinements thereof, have features which render them particularly suitable to be produced by means of the previously described manufacturing methods for a tower segment, a tower portion and a tower section for a tower, in particular for a tower of a wind power installation, and the potential refinements of the manufacturing methods. In particular, a tower portion and/or tower section and/or tower according to the invention can comprise tower segments established according to the invention, or tower segments according to the invention, respectively, as well as tower segments produced by alternative manufacturing methods. The tower according to the invention preferably comprises at least one tower segment and/or at least one tower portion and/or at least one tower section which are produced by a previously described manufacturing method according to the invention.

In terms of the advantages, variants of embodiment and details of embodiment of these further aspects and the potential refinements thereof additional reference is made to the preceding description pertaining to the corresponding features or method steps, respectively, of the manufacturing method for producing a tower segment, a tower portion and a tower section.

### BRIEF DESCRIPTION OF THE SEVERAL VIEWS OF THE DRAWINGS

Preferred embodiments of the invention will be described in an exemplary manner by means of the appended figures in which:

FIG. 1 shows a schematic three-dimensional view of a wind power installation having a tower and a nacelle;

FIG. 2 shows a schematic block diagram which shows the steps of an exemplary embodiment of a manufacturing method for manufacturing a tower segment;

FIG. 3 shows a schematic block diagram which shows exemplary steps of the method of rolling;

FIG. 4 shows a schematic block diagram which shows exemplary steps of the method of bending;

FIG. 5a shows a schematic two-dimensional view of a tower segment for a tower;

FIG. 5b shows a sectional view A-A through the tower segment shown in FIG. 2a;

FIG. 5c shows a plan view of the tower segment shown in FIG. 2a;

FIG. 6 shows a schematic three-dimensional view of the tower segment shown in FIG. 2a before and after the method step of bending, as well as a schematic three-dimensional view of a mold for bending the tower segment;

FIG. 6a shows a sectional view A-A of a tower segment of a further embodiment having a thickness profile comprising a constant portion and a transition portion;

FIG. 7 shows a schematic block diagram which shows the steps of a further embodiment of a manufacturing method for manufacturing a tower segment;

FIG. 8 shows a schematic block diagram which shows exemplary steps of the method of producing an abutting face;

FIG. 9a: shows a schematic two-dimensional view of a further tower segment for a tower;

FIG. 9b shows a schematic illustration of a thickness profile of the tower segment shown in FIG. 9a;

FIG. 9c shows a schematic illustration of a further thickness profile of the tower segment shown in FIG. 9a;

FIG. 10 shows a schematic block diagram which shows exemplary steps of the method of connecting two plates;

FIG. 11 shows a schematic three-dimensional view of a tower portion having a plurality of tower segments disposed in an annular manner in the circumferential direction;

FIG. 12 shows a schematic block diagram which shows exemplary steps of the method of connecting two or a plurality of tower portions that are disposed so as to be mutually parallel in the longitudinal direction, and the grinding and the annealing of abutting faces; and

FIG. 13 shows a schematic three-dimensional view of a tower section comprising two tower portions that are disposed so as to be mutually parallel in the longitudinal direction.

### DETAILED DESCRIPTION

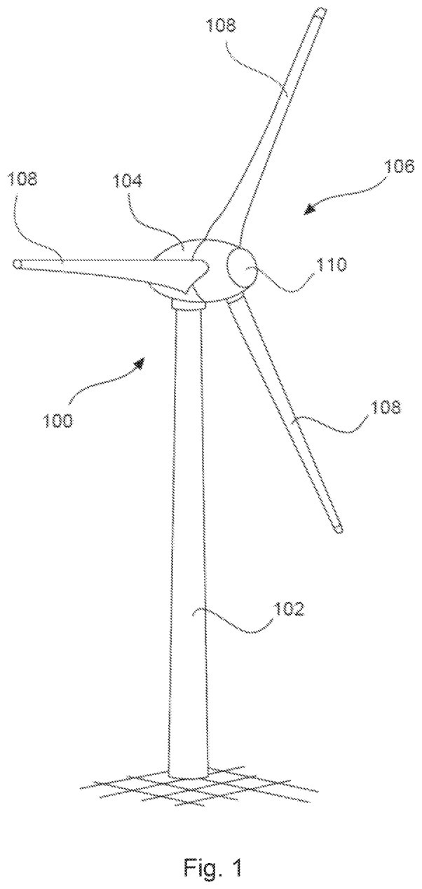

FIG. 1 shows a schematic illustration of a wind power installation according to the invention. The wind power installation 100 has a tower 102 and a nacelle 104 on the tower 102. An aerodynamic rotor 106 having three rotor blades 108 and a spinner 110 is provided on the nacelle 104. The aerodynamic rotor 106 in the operation of the wind power installation is set in rotation by the wind and thus also rotates an electrodynamic rotor or armature of a generator which is coupled directly or indirectly to the aerodynamic rotor 106. The electric generator is disposed in the nacelle 104 and generates electric power. The pitch angles of the rotor blades 108 can be varied by pitch motors on the rotor blade roots 108b of the respective rotor blades 108.

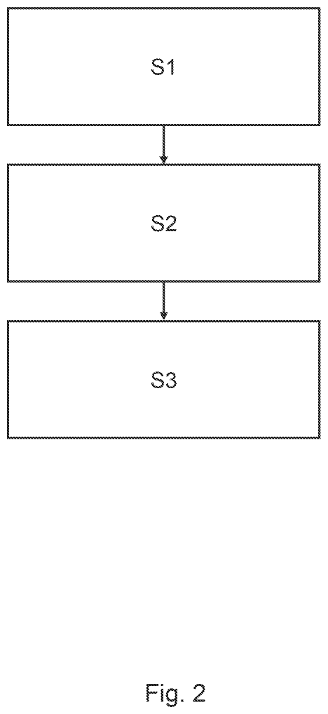

FIG. 2 shows a manufacturing method for producing a tower segment 1 of a tower 102, for example of a tower 102 of a wind power installation 100 shown in FIG. 1. The manufacturing method comprises the steps of providing S1, rolling S2 and bending S3 a plate 1a.

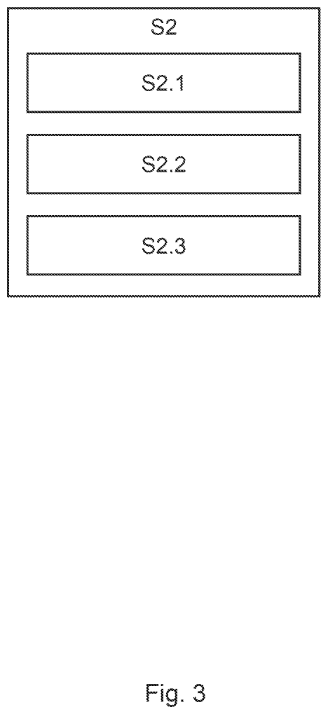

FIG. 3 shows a schematic block diagram with exemplary method steps of the rolling S2. The rolling S2 can in particular comprise the heating S2.1 of the plate 1a to a hot-rolling temperature, and/or the incorporating S2.2 of at least one transition portion U, and/or the incorporating S2.3 of at least one constant portion K1, K2, K3, K4, K5. The method step of rolling S2 can in particular comprise further forming and/or heat-treating method steps.

When incorporating S2.2 the at least one transition portion Ü, it is in particular provided that the incorporated thickness profile has a variable thickness dÜ. The thickness profile of a transition portion Ü preferably has at least two different thicknesses dÜ. When incorporating S2.3 the at least one constant portion K1, K2, K3, K4, K5 it is provided in particular that a constant portion K has a substantially constant thickness d1, d2, d3, d4, d5. Mutually dissimilar constant portions K1, K2, K3, K4, K5 can have different constant thicknesses d1, d2, d3, d4, d5. It is conceivable that one or a plurality of constant portions have the same thickness.

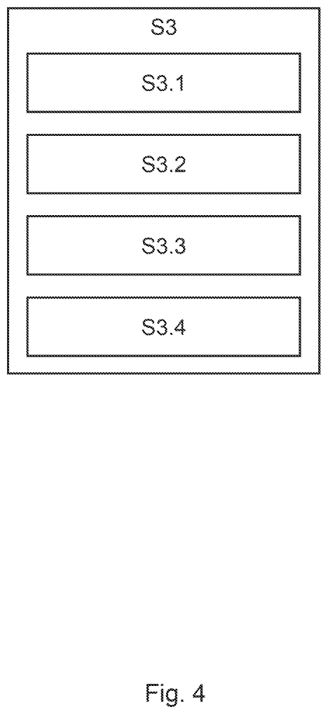

FIG. 4 shows a schematic block diagram with exemplary method steps of the bending S3. The method step of bending S3 comprises the steps of heating S3.1 the plate to a hot-bending temperature, and/or the incorporating S3.2 of a curvature x1, x2 in the circumferential direction U in the plate 1a, and/or the disposing on top of one another S3.3 of at least two plates 1a substantially orthogonal to the longitudinal direction L and the circumferential direction U of the plates 1a, and/or the disposing S3.4 of the plate on a mold 40. The plate 1a is in particular disposed on a mold 40 which is a mesh mold and/or a mold comprising concrete.

The incorporating S3.2 of a curvature x1, x2 in the circumferential direction U in the plate 1a preferably comprises incorporating the curvature by means of plastic hot-forming. For the hot-forming, the plate 1a is heated to a hot-forming temperature which is above an ambient temperature. It is furthermore particularly preferable for a curvature x1, x2 which is constant in the circumferential direction U to be incorporated in the plate 1a.

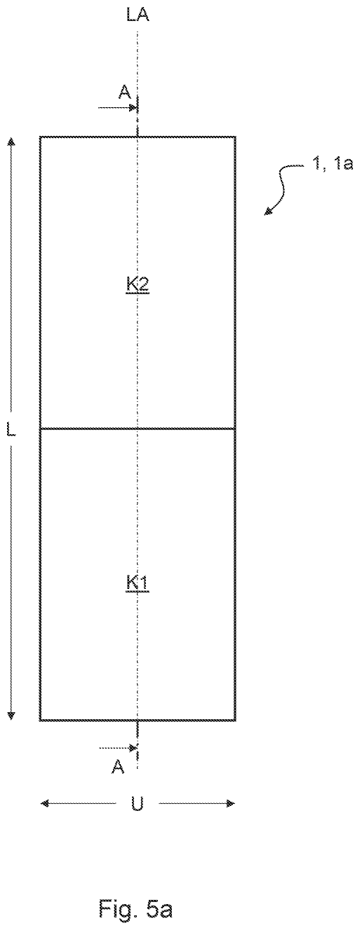

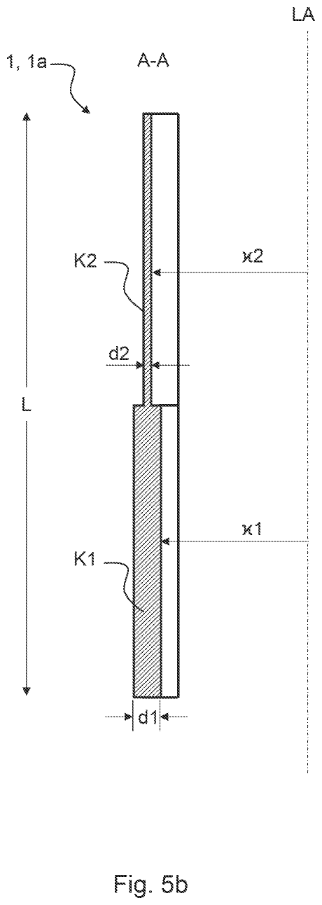

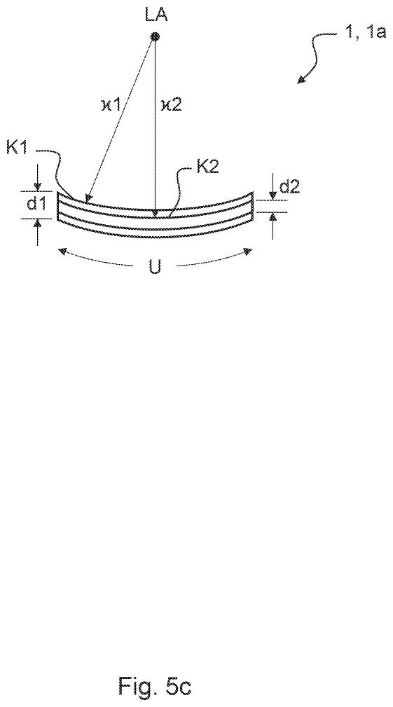

FIGS. 5a-5c show a tower segment 1 produced according to the manufacturing method illustrated in FIG. 2.

Provided according to the manufacturing method shown in FIG. 2 is to provide a plate 1a which extends in the longitudinal direction L and, orthogonal thereto, in a circumferential direction U. The plate 1a in the longitudinal direction presently extends approximately by a factor of 3 to 4 in comparison to the circumferential direction. The planar extent in the longitudinal direction L and the circumferential direction U of the plate 1a here is multiple times larger than the thickness of the plate 1a extending orthogonally thereto.

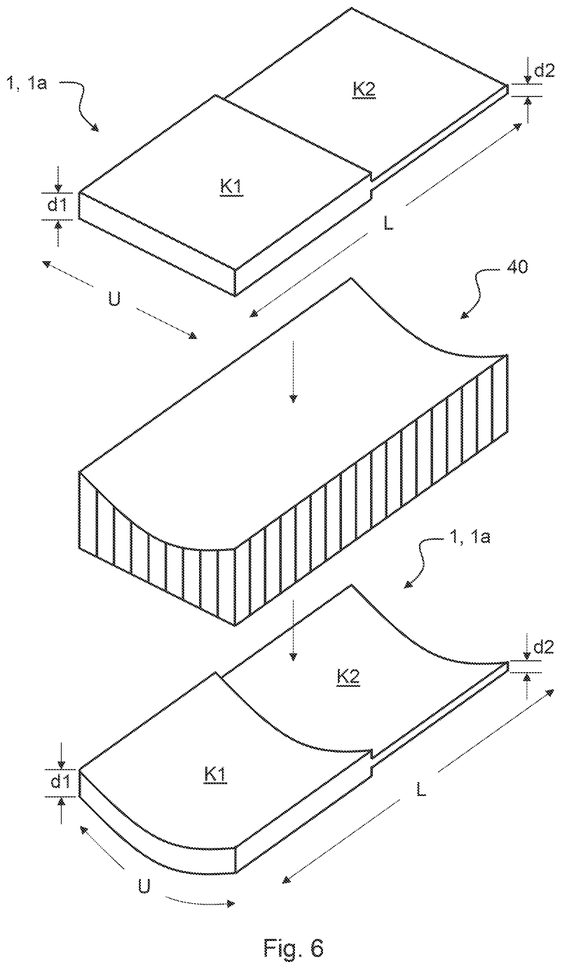

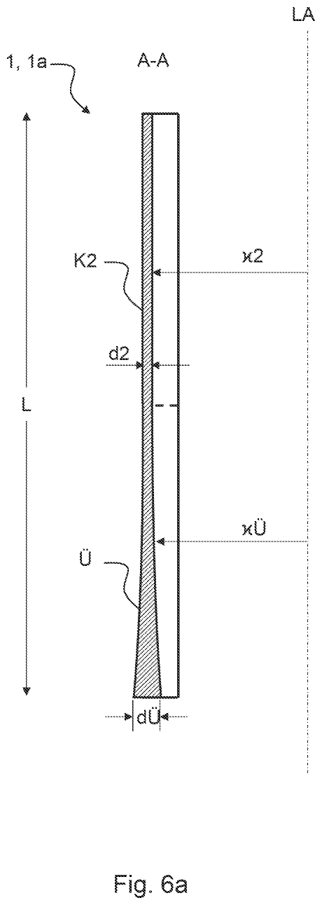

As a result of rolling S2 the provided plate 1a, a thickness profile having a variable thickness dÜ is incorporated in the longitudinal direction of said plate 1a along a longitudinal axis LA. In an exemplary manner it is provided here that a thickness profile which has a first constant portion K1 having a first thickness d1, and a second constant portion K2 having a second thickness d2 is incorporated. The tower segment 1 shown in FIGS. 5a-6 has a variable thickness profile with a discrete profile of thickness; the thickness profile of the first constant portion K1 having the thickness d1 transitions abruptly, or in steps, respectively, to the thickness profile of the second constant portion K2 having the thickness d2. The second constant portion K2 has been rolled to a thickness d2 which corresponds to approximately one third of the first thickness d1 of the first constant portion K1. The different thicknesses d1, d2 of the two constant portions K1, K2 can be derived in particular from FIGS. 5b and 5c.

The second constant portion K2 here has been incorporated in such a manner that the second constant portion K2 in the longitudinal direction L is disposed above the first constant portion K1. In particular, the two constant portions are disposed so as to be substantially mutually parallel. In the case of constant portions K1, K2 that are disposed so as to be substantially mutually parallel, the transition between the two constant portions K1, K2 extends across the circumferential direction U, so as to be perpendicular thereto. The incorporated constant portions K1, K2 here have an extent in the longitudinal direction L, or a length, respectively, which is larger than the extent of said constant portions K1, K2 in the circumferential direction U.

In the present example, the rolling S2 of the provided plate 1a comprises initially the heating S2.1 of the plate to a hot-rolling temperature. As a result, the constant portions K1, K2 having the respective substantially constant thicknesses d1, d2 in the longitudinal direction L and in the circumferential direction U per constant portion K1, K2 can subsequently be incorporated S2.2 with a lower input of force.

The bending S3 of the rolled plate 1a is provided subsequently to the rolling S2. FIG. 6 shows a schematic three-dimensional view of the tower segment 1 shown in FIGS. 5a-5c before and after the method step of bending S3, as well as a schematic three-dimensional view of a mold 40 for bending S3 the tower segment 1. A corresponding bending tool as the counterpart of the mold 40 is not shown.

FIG. 5b here shows a cross section A-A in the longitudinal direction, transversely to the circumferential direction of the tower segment 1 shown in FIG. 5a. Proceeding from a lower end of the tower segment 1, the first constant portion K1 having a thickness d1 extends to approximately the center of said tower segment 1 and, proceeding from approximately the center of the tower segment 1, the second constant portion K2 having a thickness d2 extends to an upper end. This view and the plan view of the tower segment 1 in FIG. 5c show the curvature x1, x2 in the circumferential direction of the two constant portions K1, K2 of the tower segment 1. It becomes evident from the sectional view A-A and the plan view of FIGS. 5b and 5c that the respective constant portions K1, K2 of the present tower segment 1 have been bent to a cylindrical shape. In the installed state or operating state, respectively, of the tower segment 1, the plate 1a in terms of a longitudinal axis LA has a curvature which is constant in the circumferential direction, this being a function of the respective constant portion. In that the constant portions are bent so as to be substantially cylindrical, the constant portions K1, K2, in the installed state or operating state, respectively, do not have any curvature in the longitudinal direction.

In the present example, the bending S3 comprises initially the heating S3.1 of the plate 1a to the hot-bending temperature. As a result, the plate 1a can consequently be bent S3.2 in the circumferential direction U with a lower input of force. As a result of this hot-forming, the plate is imparted a radius, or a curvature x1, x2 which is constant in the circumferential direction U, respectively, as is shown in FIGS. 5b, 5c and 6 (lower third) S3.3.

For a further embodiment of a tower segment 1, shown in FIG. 6a, in the method step of rolling S2 in the longitudinal direction L of the tower segment, a transition portion Ü is incorporated in the plate 1a, and in the installed state in the longitudinal direction a constant portion K2 is incorporated thereabove in the plate 1a. In this preferred embodiment of the manufacturing method and of the established tower segment 1, the thickness profile of the transition portion U transitions continuously to the thickness profile of the constant portion K2. The thickness profile of the transition portion Ü has a variable thickness dÜ. The thickness profile of the tower segment 1 in the transition portion Ü follows a concave profile. The thickness of the transition portion increases continuously up to an upper end of the transition portion Ü, or approximately up to the center of the tower segment 1 decreases to a thickness d2, respectively, and continuously transitions to the constant portion K2 having the constant thickness d2. The continuous transition between the transition portion Ü and the constant portion K2 is indicated by the horizontal dashed line in FIG. 6a. The transition portion has a curvature which is constant in the circumferential direction and varies in the longitudinal direction of the tower segment 1. The preferred embodiment of a tower segment 1 shown in FIG. 6a is established in a manner substantially analogous to that of the preferred embodiment of the tower segment having the two constant portions shown in FIGS. 5a-6. To this extent, the embodiments pertaining to the manufacturing method of the tower segments shown in FIGS. 5a-6 apply in a substantially analogous manner to the preferred embodiment of a tower segment illustrated in FIG. 6a.

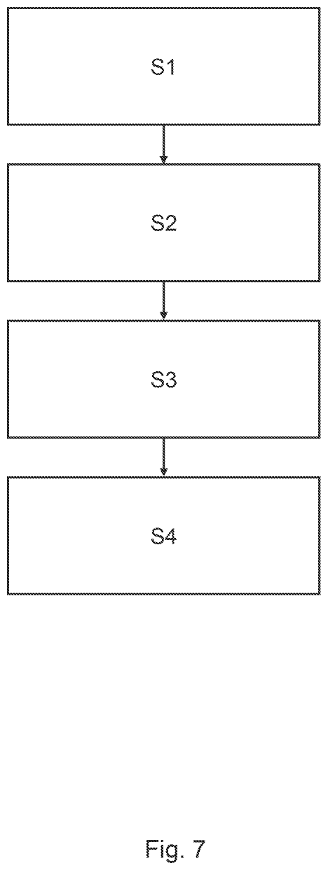

Based on the manufacturing method for producing a tower segment 1 of a tower 102 illustrated in FIG. 2, the manufacturing method illustrated in FIG. 7 additionally comprises the step of producing S4 at least one abutting face on the plate 1a.

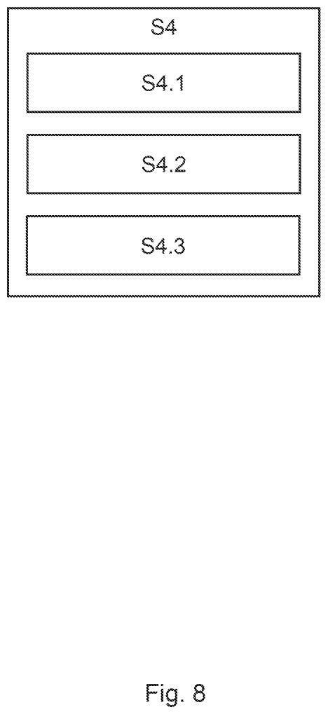

FIG. 8 shows a schematic block diagram having exemplary method steps of producing S4 at least one abutting face, for example the producing S4.1, S4.2 of at least one longitudinal abutting face 3a, 3b and/or at least one circumferential abutting face 2a, 2b for connecting at least one further plate, and/or the producing of an abutting face the removal of a peripheral portion S4.3. According to the manufacturing method shown in FIG. 7, it is furthermore provided that the rolling S2 additionally comprises incorporating S2.3 a transition portion U between two constant portions.

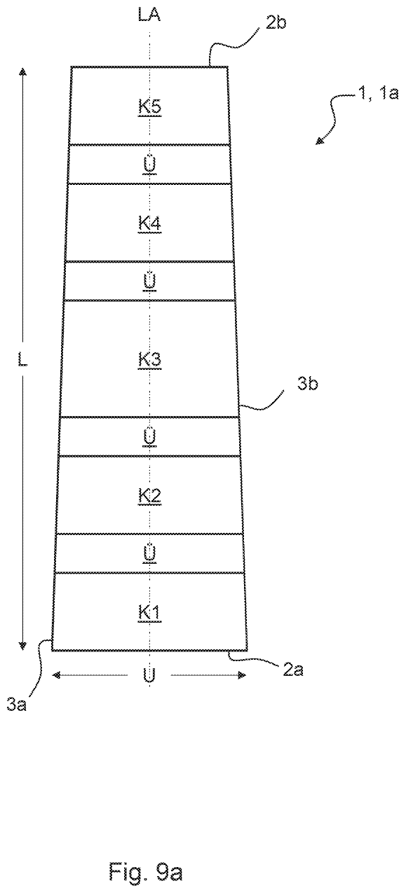

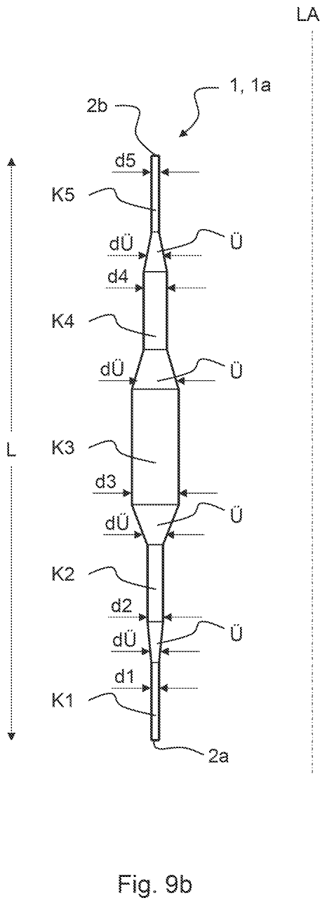

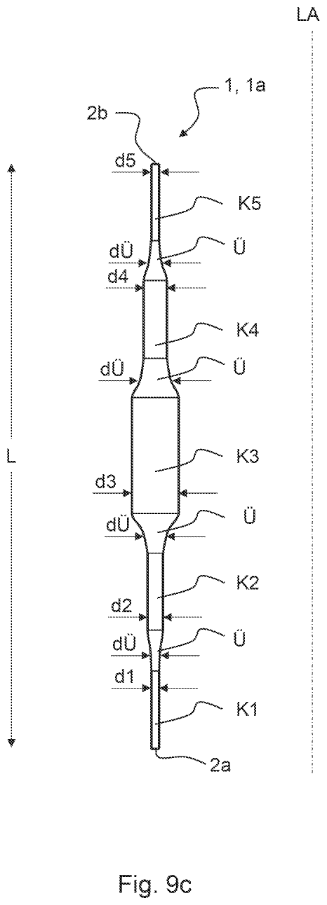

FIGS. 9a, 9b and 9c show a tower segment 1 produced by such a manufacturing method. A tower segment 1 produced by such a method in the longitudinal direction has five mutually parallel constant portions K1, K2, K3, K4, K5 having respective constant thicknesses d1, d2, d3, d4, d5 that in the installed state are disposed on top of one another in the longitudinal direction, for example. Parallel thereto, transition portions U have been incorporated between these constant portions K1 to K5 with a view to a lower notching effect. It may be preferable for a tower segment 1 at an end which in the installed state is a lower and/or an upper end to terminate by way of a transition portion Ü. In the preferred embodiments of a tower segment 1 illustrated in FIGS. 9a, 9b and 9c, the respective constant portions K1, K2, K3, K4, K5 that are disposed so as to be mutually parallel in the longitudinal direction L have an extent which is larger than the extent of the transition portions Ü in the longitudinal direction L. In further preferred embodiments it may be preferable for one or a plurality of transition portions Ü in the longitudinal direction L to have a larger extent than one or a plurality of constant portions of a tower segment 1.

The tower segment 1 illustrated in FIG. 9b shows a thickness profile in which the thickness dÜ of the respective transition portion Ü between the adjacent constant portions K1, K2, K3, K4, K5 varies in a trapezoidal manner. In particular, the thickness profile varies continuously within the individual transition portions. The thickness profile of the tower segment illustrated in FIG. 9b at the transitions between the individual portions has a discrete profile. FIG. 9c shows a thickness profile of a tower segment 1, for example according to FIG. 9a, in which the thickness dÜ of the respective transition portions U between the adjacent constant portions K1, K2, K3, K4, K5 have a concave and convex profile. In particular, the thickness profile varies continuously within the individual transition portions Ü. The thickness profile of the tower segment 1 illustrated in FIG. 9b at the transitions between the individual portions has a continuous profile. The thickness profiles shown in FIGS. 9b and 9c, in the longitudinal direction L, in terms of the installed state or operating state of the tower segment 1, respectively, proceeding from a lower end of the tower segment 1 via the constant portion K2 up to the center of the tower segment 1, thus the constant portion K3, have an increasing thickness. The thickness of the thickness profile, proceeding from the constant portion K3 via the constant portion K4 then decreases to the constant portion K5, the upper end of the tower segment 1.

In the present example, the producing S4 of at least one abutting face comprises the producing S4.1, S4.2 of an upper and a lower circumferential abutting face 2a, 2b and two longitudinal abutting faces 3a, 3b. The circumferential abutting faces 2a, 2b in the circumferential direction U extend substantially on the lower side and the upper side of the tower segment 1. The longitudinal abutting faces 3a, 3b extend substantially in the longitudinal direction L so as to be lateral on the tower segment 1. Furthermore, the producing of an abutting face comprises the removing of a peripheral portion S4.3. As a result of removing the peripheral portion S4.3, the tower segment 1 shown in FIG. 9a tapers conically in the longitudinal direction L. In particular, the tower segment 1 produced as a result, in the longitudinal direction, proceeding from a lower end of the circumferential abutting face 2a, has a taper toward an upper end of the circumferential abutting face 2b. The tower segment 1 has in particular inclined longitudinal abutting faces 3a, 3b. Such a tower segment 1 in the installed state or operating state, respectively, is disposed so as to be inclined in relation to a longitudinal axis LA that is aligned so as to be substantially vertical.

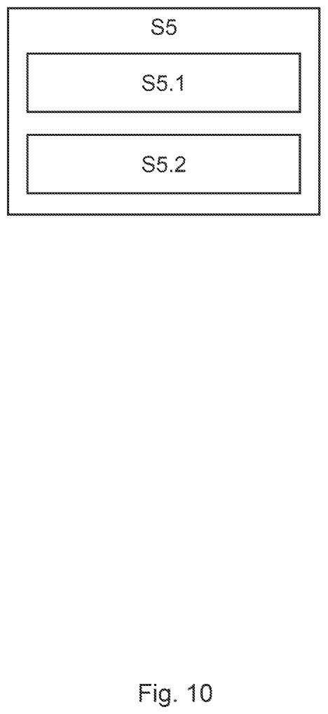

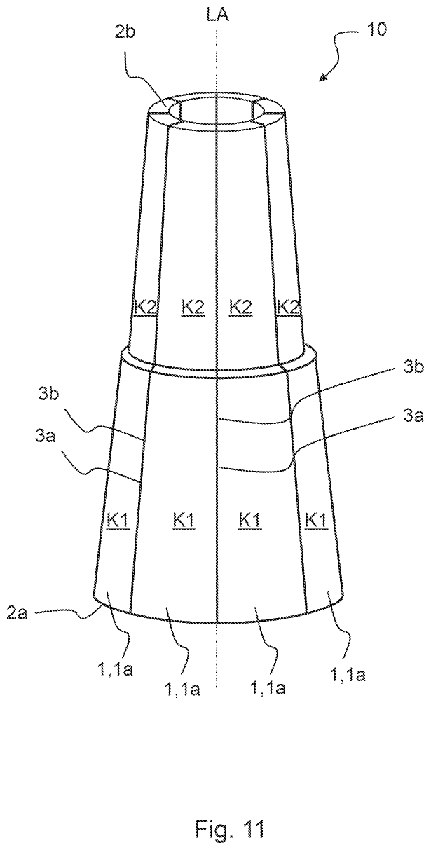

FIG. 10 shows a manufacturing method for establishing a tower portion 10. To this end, it is provided that the established plates 1a previously described are connected to one another S5 at the longitudinal abutting faces 3a, 3b, for example. A tower portion 10 established by this method is shown in FIG. 11. A tower 102 of a wind power installation 100 according to FIG. 1 can comprise, for example, a tower portion 10 established in such a manner. To this end, tower segments were produced according to the manufacturing method described as per FIG. 2, and peripheral portions of the plates 1a additionally removed and circumferential abutting faces 2a, 2b on the upper side and the lower side of the plate 1a as well as longitudinal abutting faces 3a, 3b in the longitudinal direction of the plate 1a produced S4. Eight tower segments 1 were provided and mutually disposed in an annular manner and fixed S5.1 for establishing the tower portion 10. Subsequently, a longitudinal welded connection between adjacent plates 1a was established along the longitudinal abutting faces 3a, 3b so as to be substantially parallel to the longitudinal axis LA in order for the plates 1a to be connected to one another.

In the presently illustrated exemplary embodiment, a tower portion 10 in which the constant portions K1 of adjacent tower segments 1 and the constant portions K2 of adjacent tower segments 1 have substantially identical constant thicknesses d1, d2 was established. However, it is conceivable for the constant portions K1, K2 of such tower segments that in the installed state or operating state, respectively, are disposed so as to be substantially parallel to a prevailing load direction to be produced with a comparatively smaller thickness d1, d2 than the constant portions K1, K2 of such tower segments that in the installed state or operating state, respectively, are disposed so as to be substantially transverse to the prevailing load direction.

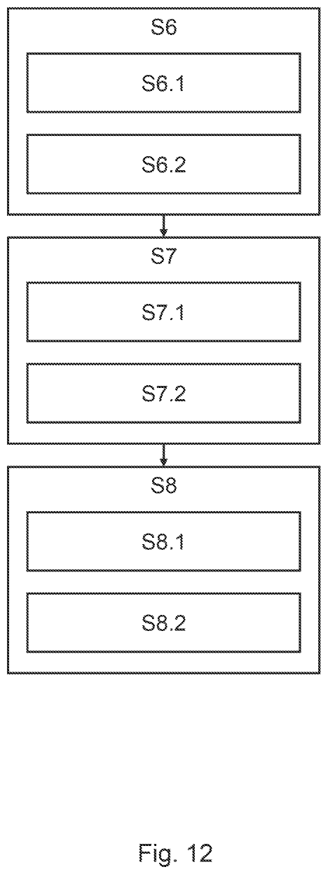

FIG. 12 shows a manufacturing method for establishing a tower section 20. To this end it is provided that two or a plurality of tower portions are connected S7, welded connections are ground S8 and/or plates in the region of the welded connections are annealed S9. The connecting S6 of two or a plurality of tower portions 10 comprises the disposing and fixing S7.1 of adjacent tower portions 10 on one another along a circumferential abutting face, and the establishing S7.2 of a circumferential welded connection. The grinding S8 comprises the grinding of the circumferential welded connection S8.1 and/or the grinding of the longitudinal welded connection S8.2. The annealing S9 comprises the annealing of the plates in the region of the circumferential welded connection S9.1 and/or the annealing of the longitudinal welded connection S9.2.

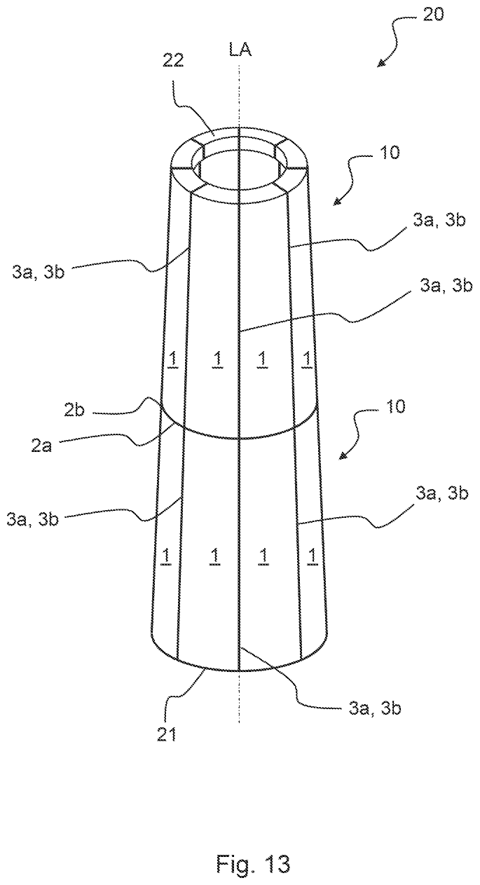

FIG. 13 shows a tower section 20 established so as to be based on the manufacturing method illustrated in FIG. 12. A tower 102 of a wind power installation 100 according to FIG. 1 can comprise a tower section 20 established in such a manner, for example. It may be preferable for a previously described tower portion and/or tower section and/or tower to comprise tower segments that are different from the manufacturing method according to the invention.

The establishing of such a tower section 20 in the present example comprises the providing of two tower portions 10 established as described above. For connecting S6 these two tower portions 10 it is provided that the two tower portions 10 are disposed and fixed S6.1 along the circumferential abutting faces 2a, 2b so as to form a tower section 20 in the longitudinal direction, and that a circumferential welded connection is subsequently established S6.2 between the adjacent tower portions 10 along the circumferential abutting faces 2a, 2b. With a view to a longer service life, the circumferential welded connections are ground S7.1 and annealed S8.1. It is furthermore provided that the tower section 20 at the lower end thereof and the upper end thereof has a lower and an upper annular flange 21, 22. The upper annular flange is provided for fastening a further tower section 20 or a nacelle 104, and the lower annular flange is provided for fastening a further tower section 20 or a foundation. The upper and the lower annular flange 21, 22 are preferably configured as a screw connection.

### LIST OF REFERENCE SIGNS

1 Tower segment
1a Plate
2a, 2b Circumferential abutting face
3a, 3b Longitudinal abutting face
10 Tower portion
20 Tower section
40 Mold, mesh mold
100 Wind power installation
102 Tower
104 Nacelle
106 Rotor
108 Rotor blade
110 Spinner
d1 . . . d5 Constant thickness of a constant portion
dÜ Variable thickness of a transition portion
K1 . . . K5 Constant portion
x1, x2 Curvature of a constant and/or transition portion portions
L Longitudinal direction
LA Longitudinal axis
U Circumferential direction
Ü Transition portion

1. A manufacturing method comprising:
producing a tower segment of a tower, said producing comprising:
rolling a plate along a longitudinal direction of the plate, wherein the plate extends in a longitudinal direction and, orthogonally to the longitudinal direction, in a circumferential direction, wherein an extent in the longitudinal direction is larger than an extent in the circumferential direction, wherein the rolling comprises:
incorporating a thickness profile having a variable thickness; and
bending the plate.

2. The manufacturing method as claimed in claim 1, wherein the rolling comprises at least one of:
heating the plate to a hot-rolling temperature;
incorporating at least one transition portion, wherein the at least one transition portion has a variable thickness of the incorporated thickness profile; or
incorporating at least one constant portion, wherein the at least one constant portion has a constant thickness of the incorporated thickness profile.

3. The manufacturing method as claimed in claim 1, wherein the bending comprises at least one of:
heating the plate to a hot-bending temperature; or
incorporating a curvature in the circumferential direction in the plate.

4. The manufacturing method as claimed in claim 1, wherein:
the thickness of the at least one transition portion varies in a stepless or stepped manner; and/or
wherein the curvature incorporated in the circumferential direction varies along the longitudinal direction of the plate.

5. The manufacturing method as claimed claim 1, comprising:
producing at least one abutting face on the plate for connecting to another plate, wherein the producing of the at least one abutting face comprises:
producing at least one longitudinal abutting face for connecting to another plate in the circumferential direction; and/or
producing Sat least one circumferential abutting face for connecting to another plate in the longitudinal direction; and/or
removing a peripheral portion of the plate.

6. A manufacturing method for establishing a tower portion comprising:
connecting two plates produced according to the manufacturing method as claimed in claim 1 at corresponding longitudinal abutting faces, wherein the connecting comprises:
disposing and fixing adjacent plates on one another along the longitudinal abutting faces so as to form an annular tower portion in the circumferential direction; and
establishing a longitudinal welded connection between the adjacent plates along the longitudinal abutting faces.

7. A manufacturing method for establishing a tower section, comprising:
connecting a plurality of tower portions produced according to the manufacturing method as claimed in claim 1 at corresponding circumferential abutting faces, wherein the connecting comprises:
disposing and fixing adjacent tower portions on one another along the circumferential abutting faces so as to form a tower section in the longitudinal direction; and
establishing a circumferential welded connection between the adjacent tower portions along the circumferential abutting faces.

8. The manufacturing method as claimed in claim 6, comprising:
grinding at least one of the circumferential welded connection or the longitudinal welded connection.

9. A tower segment of a tower, comprising:
a plate, wherein the plate extends in a longitudinal direction and, orthogonally to the longitudinal direction, in a circumferential direction, wherein an extent in the longitudinal direction is greater than an extent in the circumferential direction, and wherein the plate has a thickness profile having a variable thickness along the longitudinal direction of the plate and has at least one of:
at least one transition portion;
at least one constant portion having a substantially constant thickness; or
a curvature in the circumferential direction.

10. A tower portion of a tower, comprising:
a plurality of tower segments as claimed in claim 9, wherein the plurality of tower segments in the circumferential direction are disposed in an annular manner or as an annular sub-portion, and adjacent tower segments of plurality of tower segments are fastened to one another at longitudinal abutting faces.

11. The tower portion as claimed in claim 10, wherein a thickness of the tower portion in an installed state differs in the circumferential direction between at least two tower segments of the plurality of tower segments.

12. A tower section of a tower, comprising a plurality of tower portions as claimed in claim 10, wherein the tower portions, in an installed state, in the longitudinal direction are vertically stacked, and adjacent tower portions are fastened to one another at the circumferential abutting faces.

13. The tower section as claimed in claim 12, comprising:
an upper end, in the installed state, having an upper annular flange for fastening to an upper tower section or a nacelle; and
a lower end, in the installed state, having a lower annular flange for fastening to a lower tower section or a foundation.

14. A tower comprising the tower section as claimed in claim 12.

15. A wind power installation comprising the tower as claimed in claim 14.

16. (canceled)

17. The manufacturing method as claimed in claim 3, wherein the bending comprises incorporating a curvature in the circumferential direction in the plate, wherein the incorporating of the curvature comprises at least one of:
incorporating the curvature by plastic hot-forming;
incorporating a curvature that is constant in the circumferential direction of the plate;
disposing on top of one another at least two plates substantially orthogonal to the longitudinal direction and the circumferential direction of the plate; or
disposing the plate on a mold.

18. The manufacturing method as claimed in claim 6, annealing the plates in at least one region of the circumferential welded connection or of the longitudinal welded connection.

19. The manufacturing method as claimed in claim 7, comprising:
grinding at least one of the circumferential welded connection or the longitudinal welded connection.

20. The manufacturing method as claimed in claim 7, comprising annealing the plates in at least one region of the circumferential welded connection or of the longitudinal welded connection.
